(19) United States
(12) Patent Application Publication
(10) Pub. No.: US 2026/0171300 A1
(43) Pub. Date: Jun. 18, 2026

(54) COIL ELECTRONIC COMPONENT

(71) Applicant: SAMSUNG ELECTRO-MECHANICS CO., LTD., Suwon-si (KR)

(72) Inventors: Donghwan Lee, Suwon-si (KR); Dong Jin Lee, Suwon-si (KR); Soonkwang Kwon, Suwon-si (KR); Tae Hyun Kim, Suwon-si (KR); Juhyoung Park, Suwon-si (KR); Daeki Lim, Suwon-si (KR)

(73) Assignee: SAMSUNG ELECTRO-MECHANICS CO., LTD., Suwon-si (KR)

(21) Appl. No.: 19/272,747

(22) Filed: Jul. 17, 2025

(30) Foreign Application Priority Data
Dec. 16, 2024 (KR) 10-2024-0186761

(51) Int. Cl. H01F 27/28; H01F 27/29

(52) U.S. Cl. CPC H01F 27/2828; H01F 27/292

(57) ABSTRACT

An embodiment provides a coil electronic component comprising a first coil and a second coil spaced apart from the first coil, an anisotropic magnetic layer positioned between the first coil and the second coil, and a body enclosing the first coil, the second coil, and the anisotropic magnetic layer. The anisotropic magnetic layer includes plate-shaped or flake-shaped magnetic particles and is configured to adjust a coupling coefficient between the first coil and the second coil. The body comprises a magnetic material, providing a compact and efficient structure suitable for use in power management and other high-frequency applications.

### CROSS-REFERENCE TO RELATED APPLICATION

This application claims priority to and the benefit of Korean Patent Application No. 10-2024-0186761 filed with the Korean Intellectual Property Office on Dec. 16, 2024, the entire contents of which are incorporated herein by reference.

### BACKGROUND

### (a) Field

The present disclosure relates to a coil electronic component.

### (b) Description of the Related Art

As functions of mobile devices have diversified recently, power consumption has increased, and to increase a battery usage time in the mobile devices, coil electronic components with low loss and high efficiency are being used around power semiconductors (power management integrated circuits (PMIC)).

When a coil electronic component has an array-type inductor structure including a first coil and a second coil, a method for easily controlling a coupling coefficient (k) between the first coil and the second coil is required.

### SUMMARY

An aspect of embodiments attempts to provide a coil electronic component having an array-type inductor structure capable of easily adjusting a coupling coefficient.

However, the problem to be solved by the present embodiments is not limited to the above-described problems, and can be variously extended within the scope of the technical spirit included in the present disclosure.

An embodiment provides a coil electronic component including a first coil, a second coil spaced apart from the first coil, an anisotropic magnetic layer disposed between the first coil and the second coil, and a body surrounding the first coil, the second coil, and the anisotropic magnetic layer, and including a magnetic material.

The anisotropic magnetic layer may be in contact with both the first coil and the second coil.

The anisotropic magnetic layer may include plate-shaped or flake-shaped particles.

The plate-shaped or flake-shaped particles may include at least one of iron (Fe), a nickel-iron alloy (NiFe), an iron-silicon-aluminum alloy (FeSiAl), or an iron-silicon-chromium alloy (FeSiCr).

The anisotropic magnetic layer may include a portion flush with an outer surface of the body.

The coil electronic component may further include a first support member and a second support member embedded in the body and spaced apart from each other, the first coil may be disposed on the first support member, and the second coil may be disposed on the second support member.

The first coil may include two coil patterns each of which is disposed on opposite surfaces of the first support member and that are connected to each other through a via penetrating the first support member, and the second coil may include two coil patterns each of which is disposed on opposite surfaces of the second support member and that are connected to each other through a via penetrating the second support member.

The body may include a laminate having a plurality of magnetic sheets stacked, and each of the first coil and the second coil may include a plurality of conductive patterns disposed on each of the magnetic sheets and connected to each other.

Each of the first coil and the second coil may include at least one turn of a conductive wire.

The coil electronic component may further include an insulating layer disposed on a surface of the conductive wire.

The coil electronic component may further include a plurality of external electrodes disposed outside the body and connected to the first coil and the second coil.

The plurality of external electrodes may include a metal.

The plurality of external electrodes may include a metal and glass.

The coil electronic component may further include a surface insulating layer covering at least a portion of a surface of the body.

In accordance with the coil electronic component according to an embodiment, the coupling coefficient between the first coil and the second coil may be easily adjusted.

### BRIEF DESCRIPTION OF THE DRAWINGS

FIG. 1 illustrates a schematic perspective view showing a coil electronic component according to an embodiment.

FIG. 2 illustrates a schematic cross-sectional view taken along line I-I′ of FIG. 1.

FIG. 3 illustrates an enlarged perspective view of a metal particle having shape isotropy.

FIG. 4 illustrates an enlarged perspective view of a metal particle having shape anisotropy.

FIG. 5 illustrates a schematic perspective view showing a coil electronic component according to another embodiment.

FIG. 6 illustrates a schematic cross-sectional view taken along line II-II′ of FIG. 5.

FIG. 7 illustrates a schematic perspective view showing a coil electronic component according to another embodiment.

FIG. 8 illustrates a schematic cross-sectional view taken along line III-III′ of FIG. 7.

FIG. 9 illustrates a schematic perspective view showing a coil electronic component according to another embodiment.

FIG. 10 illustrates an exploded perspective view showing a body of the coil electronic component of FIG. 9.

### DETAILED DESCRIPTION

Hereinafter, various embodiments of the present disclosure will be described in detail so that a person of ordinary skill in the technical field to which the present disclosure belongs can be easily implemented it with reference to the accompanying drawings. The drawings and description are to be regarded as illustrative in nature and not restrictive. Like reference numerals designate like elements throughout the specification. In addition, some components in the accompanying drawings are exaggerated, omitted, or schematically illustrated, and the size of each component does not fully reflect the actual size.

The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

It will be further understood that terms “comprises/includes” or “have” used throughout the specification specify the presence of stated features, numerals, steps, operations, components, parts, or a combination thereof, but do not preclude the presence or addition of one or more other features, numerals, steps, operations, components, parts, or a combination thereof. Accordingly, unless explicitly described to the contrary, the word “comprise” and variations such as “comprises” or “comprising” will be understood to imply the inclusion of stated components but not the exclusion of any other components.

Further, throughout the specification, the phrase “in a plan view” means when an object portion is viewed from above, and the phrase “in a cross-sectional view” means when a cross-section taken by vertically cutting an object portion is viewed from the side.

In addition, throughout the specification, “connected” means that two or more components are not only directly connected, but two or more components may be connected indirectly through other components, physically connected as well as being electrically connected, or it may be referred to by different names depending on the location or function, but may mean integral.

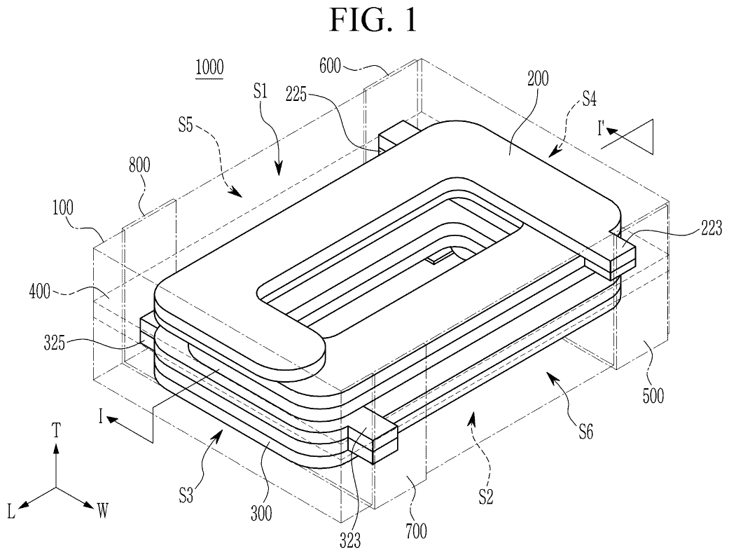

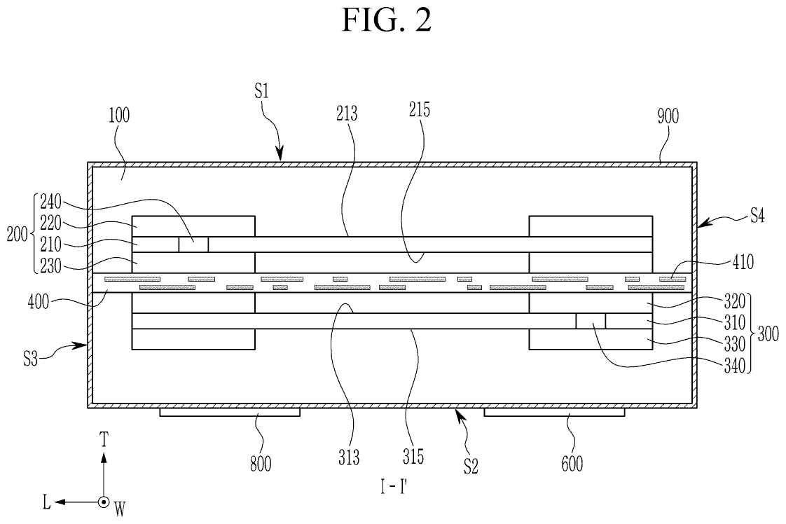

FIG. 1 illustrates a schematic perspective view showing a coil electronic component according to an embodiment, and FIG. 2 illustrates a schematic cross-sectional view taken along line I-I′ of FIG. 1.

Referring to FIG. 1 and FIG. 2, the coil electronic component 1000 according to an embodiment may correspond to an array inductor including a plurality of coils 200 and 300 spaced apart from each other.

The coil electronic component 1000 may include a body 100, a first coil 200, a second coil 300, an anisotropic magnetic layer 400, a first external electrode 500, a second external electrode 600, a third external electrode 700, and a fourth external electrode 800.

First, to clearly describe the present embodiment, directions are defined as follows: the T-axis, the L-axis, and the W-axis indicated in the drawings represent axes indicating a first direction, a second direction, and a third direction of the coil electronic component 1000, respectively.

The first direction T may be a direction parallel to the winding axes of the coils 200 and 300. Hereinafter, when necessary, the first direction may be described as a “thickness direction.”

The second direction L may be a direction along a long side of the coil electronic component 1000 when viewed from the first direction T, and may be a direction that intersects (or is orthogonal to) the thickness direction T. Hereinafter, when necessary, the second direction may be described as a “length direction.”

The third direction W may be a direction along a short side of the coil electronic component 1000 when viewed from the first direction T, and may be a direction that intersects (or is orthogonal to) both the first direction T and the second direction L. Hereinafter, when necessary, the third direction may be described as a “width direction.”

The body 100 may have a substantially rectangular hexahedral shape, but the present embodiment is not limited thereto. Due to shrinkage of magnetic powder, etc. during sintering, the body 100 may have a substantially rectangular parallelepiped shape, although it is not a perfect rectangular parallelepiped shape. For example, the body 100 has a substantially rectangular parallelepiped shape, but portions corresponding to corners or vertices may each have a rounded shape.

In the present embodiment, for better understanding and ease of description, two surfaces opposing each other in the thickness direction T of the coil electronic component 1000 are defined as a first surface S1 and a second surface S2, respectively, two surfaces opposing each other in a longitudinal direction L of the coil electronic component 1000 are defined as a third surface S3 and a fourth surface S4, respectively, and two surfaces opposing each other in a width direction W of the coil electronic component 1000 are defined as a fifth surface S5 and a sixth surface S6, respectively.

A length of the coil electronic component 1000 may refer to, based on an optical microscope or scanning electron microscope (SEM) photograph of a cross-section taken along the length direction L-thickness direction T at a center of the coil electronic component 1000 in the width direction W, a maximum value among lengths of a plurality of line segments that connect two outermost boundary lines opposing each other in the length direction L of the coil electronic component 1000 shown in the cross-sectional photograph described above and are parallel to the length direction L. Alternatively, the length of the coil electronic component 1000 may refer to a minimum value among lengths of a plurality of line segments that connect two outermost boundary lines opposing each other in the length direction L of the coil electronic component 1000 illustrated in the cross-sectional photograph described above and are parallel to the length direction L. Alternatively, the length of the coil electronic component 1000 may refer to an arithmetic average value of the lengths of at least two line segments among a plurality of line segments that connect two outermost boundary lines opposing each other in the length direction L of the coil electronic component 1000 shown in the cross-sectional photograph described above and are parallel to the length direction L.

A thickness of the coil electronic component 1000 may refer to, based on an optical microscope or scanning electron microscope (SEM) photograph of a cross-section taken along the length direction L-thickness direction T at a center of the coil electronic component 1000 in the width direction W, a maximum value among lengths of a plurality of line segments that connect two outermost boundary lines opposing each other in the thickness direction T of the coil electronic component 1000 shown in the cross-sectional photograph described above and are parallel to the thickness direction T. Alternatively, the thickness of the coil electronic component 1000 may refer to a minimum value among lengths of a plurality of line segments that connect two outermost boundary lines opposing each other in the thickness direction T of the coil electronic component 1000 illustrated in the cross-sectional photograph described above and are parallel to the thickness direction T. Alternatively, the thickness of the coil electronic component 1000 may refer to an arithmetic average value of the lengths of at least two line segments among a plurality of line segments that connect two outermost boundary lines opposing each other in the thickness direction T of the coil electronic component 1000 illustrated in the cross-sectional photograph described above and are parallel to the thickness direction T.

A width of the coil electronic component 1000 may refer to, based on an optical microscope or scanning electron microscope (SEM) photograph of a cross-section taken along the length direction L-width direction W at a center of the coil electronic component 1000 in the thickness direction T, a maximum value among lengths of a plurality of line segments that connect two outermost boundary lines opposing each other in the width direction W of the coil electronic component 1000 shown in the cross-sectional photograph described above and are parallel to the width direction W. Alternatively, the width of the coil electronic component 1000 may refer to a minimum value among lengths of a plurality of line segments that connect two outermost boundary lines opposing each other in the width direction W of the coil electronic component 1000 illustrated in the cross-sectional photograph described above and are parallel to the width direction W. Alternatively, the width of the coil electronic component 1000 may refer to an arithmetic average value of the lengths of at least two line segments among a plurality of line segments that connect two outermost boundary lines opposing each other in the width direction W of the coil electronic component 1000 illustrated in the cross-sectional photograph described above and are parallel to the width direction W.

Each of the length, width, and thickness of the coil electronic component 1000 may be measured by a micrometer measurement method. In the micrometer measurement method, a zero point is set with a micrometer providing repeatability and reproducibility (Gage R&R), the coil electronic component 1000 according to the present embodiment is inserted between tips of the micrometer, and a measuring lever of the micrometer is turned for the measurement. When measuring the length of the coil electronic component 1000 by the micrometer measurement method, the length of the coil electronic component 1000 may mean a value measured once or mean an arithmetic average of values measured a plurality of times. This may be equally applied to measuring the width and thickness of the coil electronic component 1000.

The body 100 may encapsulate and surround the first coil 200, the second coil 300, the anisotropic magnetic layer 400, a first support member 210 and a second support member 310, and may include a magnetic material. The body 100 may include magnetic particles, and an insulating material may be present between the magnetic particles.

The magnetic material may include a first metal magnetic particle, a second metal magnetic particle having a smaller particle size than that of the first metal magnetic particle, and a third metal magnetic particle having a smaller particle size than that of the second metal magnetic particle. An average particle diameter D₅₀ of the first metal magnetic particle may be 5 μm or more and 30 μm or less, an average particle diameter D₅₀ of the second metal magnetic particle may be 1 μm or more and 5 μm or less, and an average particle diameter D₅₀ of the third metal magnetic particle may be 0.05 μm or more and 0.5 μm or less.

The magnetic particles may be ferrite particles or metal magnetic particles exhibiting magnetic characteristics.

The ferrite particles may include, for example, at least one of spinel-type ferrites such as Mg—Zn-based, Mn—Zn-based, Mn—Mg-based, Cu—Zn-based, Mg—Mn—Sr-based, Ni—Zn-based ferrites, hexagonal ferrites such as Ba—Zn-based, Ba—Mg-based, Ba—Ni-based, Ba—Co-based, Ba—Ni—Co-based ferrites, garnet-type ferrites such as Y-based ferrites and Li-based ferrite.

The metal magnetic particles may be composed of two or more types of powders having different compositions, and may include at least one selected from the group consisting of iron (Fe), silicon (Si), chromium (Cr), cobalt (Co), molybdenum (Mo), aluminum (Al), niobium (Nb), copper (Cu), and nickel (Ni). For example, metal magnetic particles may be at least one of pure iron, Fe—Si-based alloy, Fe—Si—Al-based alloy, Fe—Ni-based alloy, Fe—Ni—Mo-based alloy, Fe—Ni—Mo—Cu-based alloy, Fe—Co-based alloy, Fe—Ni—Co-based alloy, Fe—Cr-based alloy, Fe—Cr—Si-based alloy, Fe—Si—Cu—Nb-based alloy, Fe—Ni—Cr-based alloy, Fe—Cr—Al-based alloy. Here, different compositions of the metal magnetic particles may mean different contents.

The metal magnetic particles may be amorphous or crystalline. For example, the metal magnetic particles may be an Fe—Si—B—Cr amorphous alloy, but the present embodiment is not limited thereto. The metal magnetic particles may have an average particle diameter of about 0.1 μm to 30 μm, but the embodiment is not limited thereto. In the specification, the average particle size may mean a particle size distribution expressed by D₉₀, D₅₀, etc. The particle size distribution is well known to those skilled in the art as an index indicating what size (particle diameter) particles are included in what proportion in a particle group to be measured. D₅₀ (a particle diameter corresponding to 50% of a cumulative volume of the particle size distribution) refers to an average particle diameter.

The metal magnetic particles may be two or more types of different metal magnetic particles. As used herein, different types of metal magnetic particles refer to particles distinguished from each other in at least one of the following aspects: average particle diameter, composition, component ratio, crystallinity, or shape.

The insulating material may include epoxy, polyimide, liquid crystal polymer, etc., alone or in combination, but the embodiment is not limited thereto.

The method of forming the body 100 is not particularly limited. For example, sheets of magnetic material may be disposed at an upper portion and a lower portion of the first coil 200 and the second coil 300, and then pressed and cured to form the body 100.

The first coil 200 and the second coil 300 may be embedded in the body 100 to exhibit the characteristics of the coil electronic component 1000. For example, when the first coil electronic component 1000 of the present embodiment is used as a power inductor, when a current is applied to the first coil 200 and the second coil 300, the coils may serve to stabilize the power supply of an electronic device by storing energy in the form of a magnetic field to maintain an output voltage.

The first coil 200 may include a first support member 210, a first coil pattern 220, a second coil pattern 230, and a first via 240.

The first support member 210 may include a first surface 213 and a second surface 215 opposing each other in the thickness direction T, and may be made of an insulating material.

The first coil pattern 220 may be disposed on the first surface 213 of the first support member 210, and the second coil pattern 230 may be disposed on the second surface 215 of the first support member 210. The first coil pattern 220 and the second coil pattern 230 may be formed using any plating process used in the art, such as pattern plating, anisotropic plating, or isotropic plating, and may be formed into a multilayer structure using a plurality of these processes.

The first via 240 may penetrate the first support member 210 to connect the first coil pattern 220 and the second coil pattern 230.

The second coil 300 may include a second support member 310, a third coil pattern 320, a fourth coil pattern 330, and a second via 340.

The second support member 310 may include a first surface 313 and a second surface 315 opposing each other in the thickness direction T, and may be made of an insulating material.

The third coil pattern 320 may be disposed on the first surface 313 of the second support member 310, and the fourth coil pattern 330 may be disposed on the second surface 315 of the second support member 310. The third coil pattern 320 and the fourth coil pattern 330 may be formed using any plating process used in the art, such as pattern plating, anisotropic plating, or isotropic plating, and may be formed into a multilayer structure using a plurality of these processes.

The second via 340 may penetrate the second support member 310 to connect the third coil pattern 320 and the fourth coil pattern 330.

The anisotropic magnetic layer 400 may be a layer made of an anisotropic magnetic material.

The anisotropic magnetic layer 400 may be disposed between the first coil 200 and the second coil 300. For example, the anisotropic magnetic layer 400 may be in contact with each of the first coil 200 and the second coil 300.

The anisotropic magnetic layer 400 may include a portion that is flush with an outer surface of the body 100. For example, when viewed in the thickness direction T, the anisotropic magnetic layer 400 has a rectangular shape, with four edges that are flush with a first surface S1, a second surface S2, a third surface S3, and a fourth surface S4 of the body 100, respectively.

The anisotropic magnetic layer 400 may include metal particles 410 with shape anisotropy.

The metal particles 410 with shape anisotropy may be dispersed in a thermosetting resin. Herein, the thermosetting resin may be, e.g., an epoxy resin or polyimide.

For example, the anisotropic magnetic layer 400 may be formed of a composite magnetic material in which soft magnetic metal particles are dispersed in a resin material. In addition, the soft magnetic metal particle in the anisotropic magnetic layer 400 may be a particle including iron (Fe), a nickel-iron alloy (NiFe), an iron-cobalt alloy (FeCo), an iron-silicon-aluminum alloy (FeSiAl), an iron-silicon-chromium alloy (FeSiCr), or an iron (Fe)-based amorphous metal or a cobalt (Co)-based amorphous metal.

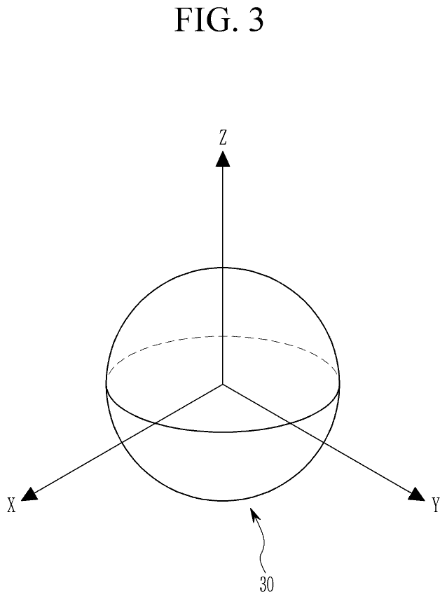

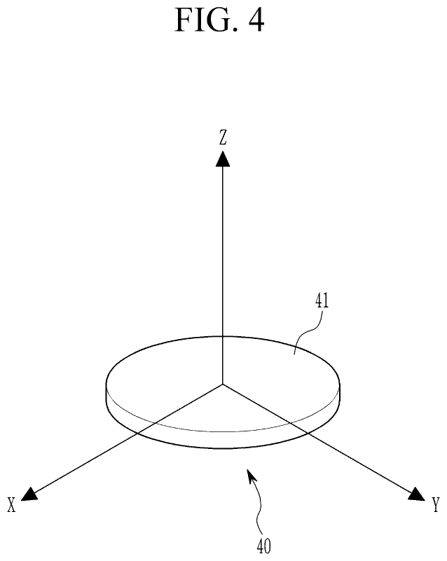

FIG. 3 illustrates an enlarged perspective view of a metal particle with shape isotropy, and FIG. 4 illustrates an enlarged perspective view of a metal particle with shape anisotropy.

Referring to FIG. 3, the metal particle 30 with shape isotropy may be represented as spherical. When a shape exhibits the same properties in the x-axis, y-axis, and z-axis directions, it is referred to as shape isotropy.

The metal particle 30 with shape isotropy may exhibit the same magnetic permeability in the x-axis, y-axis, and z-axis directions.

The metal particle 40 with shape anisotropy have different properties in the x-axis, y-axis, and z-axis directions.

Referring to FIG. 4, the metal particle 40 with shape anisotropy may be represented as, e.g., plate-shaped metal particles.

The metal particles 40 with shape anisotropy may be formed to have a plate or flake shape by a room temperature press or the like during a manufacturing process, and have a stretched shape in the x-axis and y-axis directions orthogonal to the z-axis direction. Easy magnetization directions of the metal particles 40 with shape anisotropy may be the x-axis and y-axis directions orthogonal to the z-axis direction.

In general, the metal particles 40 with shape anisotropy may exhibit higher magnetic permeability than the metal particles 30 with shape isotropy.

The metal particles 40 having shape anisotropy have different magnetic permeabilities in different directions, even though the overall magnetic permeability is higher than that of the metal particles 30 having shape isotropy, the magnetic permeability in a certain direction is very low, which may impede the flow of magnetic flux generated by the current applied to the coil.

For example, the metal particles 40 having shape anisotropy shown in FIG. 4 may have a high magnetic permeability in the x-axis and y-axis directions on a plate surface 41, but a very low magnetic permeability in the z-axis direction perpendicular to the plate surface 41.

In the present embodiment, an anisotropic magnetic layer 400 that includes the aforementioned metal particles 40 having shape anisotropy may be disposed between the first coil 200 and the second coil 300. In particular, the anisotropic magnetic layer 400 may be disposed such that the metal particles 40 having shape anisotropy impede the flow of magnetic flux. That is, the anisotropic magnetic layer 400 may be disposed such that the direction perpendicular to the plate surface 41 is parallel to the thickness direction T of the coil electronic component 1000. Accordingly, the flow of magnetic flux generated by the current applied to the first coil 200 and the second coil 300 may be impeded in the thickness direction T. Using this, a coupling coefficient between the first coil 200 and the second coil 300 may be adjusted.

Unlike in the present embodiment, a magnetic layer containing metal particles having shape isotropy and a high magnetic permeability may be disposed between the first coil and the second coil to adjust the coupling coefficient. However, magnetic layers with high magnetic permeability are difficult to make thin because of the large grain size of the metal powder included in the magnetic layer. This method may be difficult to apply to thin coil electronic components.

On the other hand, according to the present embodiment, the metal particles included in the anisotropic magnetic layer 400 may have a plate or flake shape, it may be easy to make the anisotropic magnetic layer 400 thin. Accordingly, the present embodiment may be applicable to coil electronic components having various thicknesses.

The first external electrode 500 and the second external electrode 600 may be disposed outside the body 100 and electrically connected to the first coil 200.

A first lead-out portion 223 of the first coil 200 may be exposed from the sixth surface S6 of the body 100 to be connected to the first external electrode 500. The first external electrode 500 may extend from the sixth surface S6 of the magnetic body onto the second surface S2. In addition, a second lead-out portion 225 of the first coil 200 may be exposed from the fifth surface S5 of the body 100 to be connected to the second external electrode 600. The second external electrode 600 may extend from the fifth surface S5 of the magnetic body onto the second surface S2.

The third external electrode 700 and the fourth external electrode 800 may be disposed outside the body 100 and electrically connected to the second coil 300.

A first lead-out portion 323 of the second coil 300 may be exposed from the sixth surface S6 of the body 100 to be connected to the third external electrode 700. The third external electrode 700 may extend from the sixth surface S6 of the magnetic body onto the second surface S2. In addition, a second lead-out portion 325 of the second coil 300 may be exposed from the fifth surface S5 of the body 100 to be connected to the fourth external electrode 800. The fourth external electrode 800 may extend from the fifth surface S5 of the magnetic body onto the second surface S2.

A surface insulating layer 900 may be disposed in regions of the body 100 other than the regions where the first external electrode 500, the second external electrode 600, the third external electrode 700, and the fourth external electrode 800 are disposed.

As described above, the surface insulating layer 900 may be disposed on at least a portion of the first surface S1, the second surface S2, the third surface S3, the fourth surface S4, the fifth surface S5, and the sixth surface S6 of the body 100 to prevent electrical short circuits between other electronic components and the external electrodes 500, 600, 700, and 800.

The surface insulating layer 900 may be used as a resist when forming the external electrodes 500, 600, 700, and 800 by electroplating, but the present disclosure is not limited thereto.

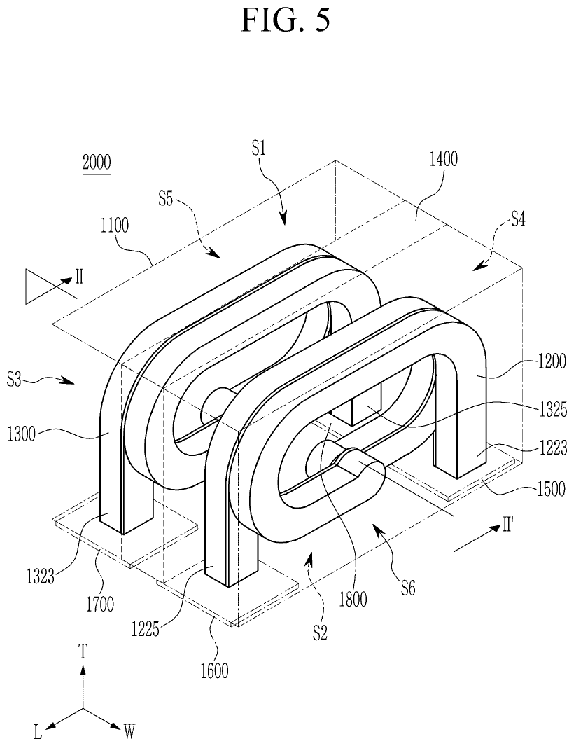

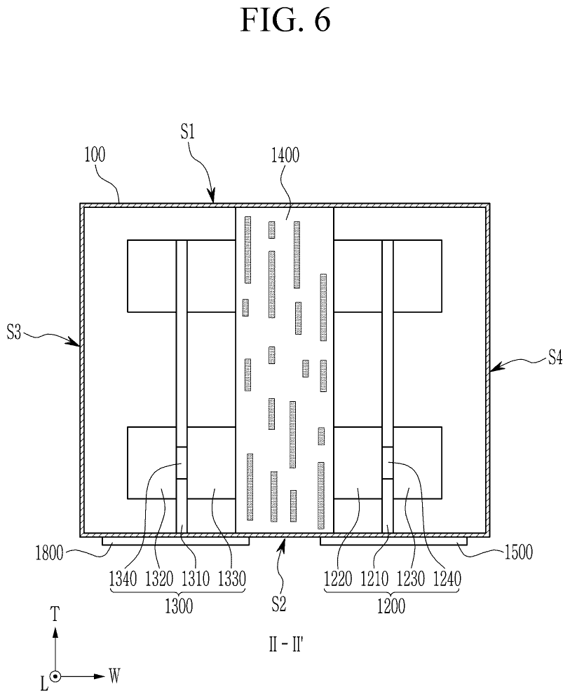

FIG. 5 illustrates a schematic perspective view showing a coil electronic component according to another embodiment, and FIG. 6 illustrates a schematic cross-sectional view taken along line II-II′ of FIG. 5.

Referring to FIG. 5 and FIG. 6, the coil electronic component 2000 may include a body 1100, a first coil 1200, a second coil 1300, an anisotropic magnetic layer 1400, a first external electrode 1500, a second external electrode 1600, a third external electrode 1700, and a fourth external electrode 1800.

The first coil 1200 and the second coil 1300 may be disposed opposite each other in the width direction W. That is, the respective winding axes of the first coil 1200 and the second coil 1300 may be parallel to the width direction W of the body 1100.

The first coil 1200 may include a first support member 1210, a first coil pattern 1220, a second coil pattern 1230, and a first via 1240.

The second coil 1300 may include a second support member 1310, a third coil pattern 1320, a fourth coil pattern 1330, and a second via 1340.

The anisotropic magnetic layer 1400 may be disposed between the first coil 1200 and the second coil 1300.

A first lead-out portion 1223 of the first coil 1200 may be exposed from the second surface S2 of the body 1100 to be connected to the first external electrode 1500. In addition, a second lead-out portion 1225 of the first coil 1200 may be exposed from the second surface S2 of the body 1100 to be connected to the second external electrode 1600.

A first lead-out portion 1323 of the second coil 1300 may be exposed from the second surface S2 of the body 1100 to be connected to the third external electrode 1700. In addition, a second lead-out portion 1325 of the second coil 1300 may be exposed from the second surface S2 of the body 1100 to be connected to the fourth external electrode 1800.

A surface insulating layer 900 may be disposed in regions of the body 1100 other than the regions where the first external electrode 1500, the second external electrode 1600, the third external electrode 1700, and the fourth external electrode 1800 are disposed.

The remaining components are identical to the components of the coil electronic component shown in FIG. 1, so a redundant description thereof will be omitted.

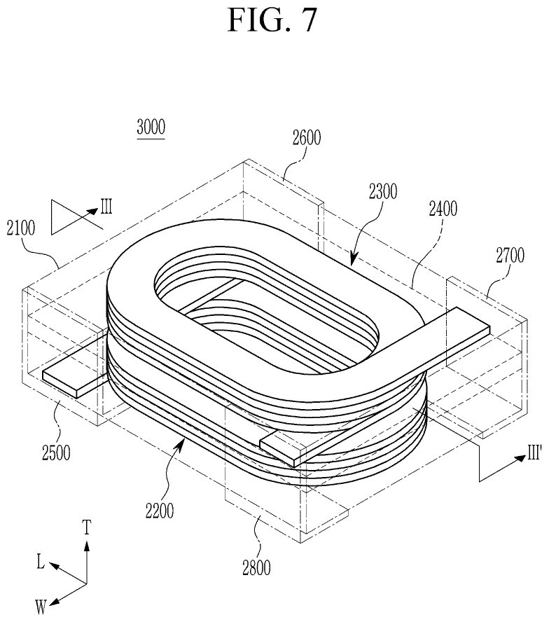

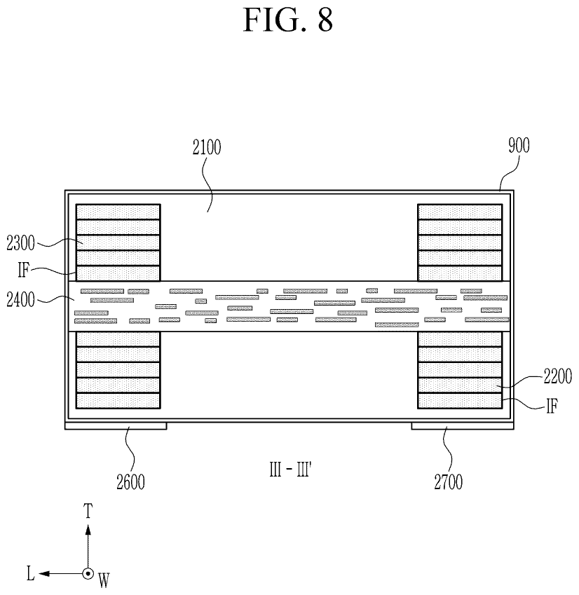

FIG. 7 illustrates a schematic perspective view showing a coil electronic component according to another embodiment, and FIG. 8 illustrates a schematic cross-sectional view taken along line III-III′ of FIG. 7.

Referring to FIG. 7 and FIG. 8, the coil electronic component 3000 may include a body 2100, a first coil 2200, a second coil 2300, an anisotropic magnetic layer 2400, a first external electrode 2500, a second external electrode 2600, a third external electrode 2700, and a fourth external electrode 2800.

The first coil 2200 and the second coil 2300 may be embedded in the body 2100 spaced apart from each other in the thickness direction T.

The first coil 2200 may include at least one turn of a conductive wire. An insulating layer IF may be disposed on a surface of the first coil 2200.

The second coil 2300 may include at least one turn of a conductive wire. An insulating layer IF may be disposed on a surface of the second coil 2300.

The anisotropic magnetic layer 2400 may be disposed between the first coil 2200 and the second coil 2300. The anisotropic magnetic layer 2400 may be in contact with each of the first coil 2200 and the second coil 2300.

The first external electrode 2500 and the second external electrode 2600 may be disposed outside the body 2100 and electrically connected to the first coil 2200.

The third external electrode 2700 and the fourth external electrode 2800 may be disposed outside the body 2100 and electrically connected to the second coil 2300.

A surface insulating layer 900 may be disposed in regions of the body 2100 other than the regions where the first external electrode 2500, the second external electrode 2600, the third external electrode 2700, and the fourth external electrode 2800 are disposed.

The remaining components are identical to the components of the coil electronic component shown in FIG. 1, so a redundant description thereof will be omitted.

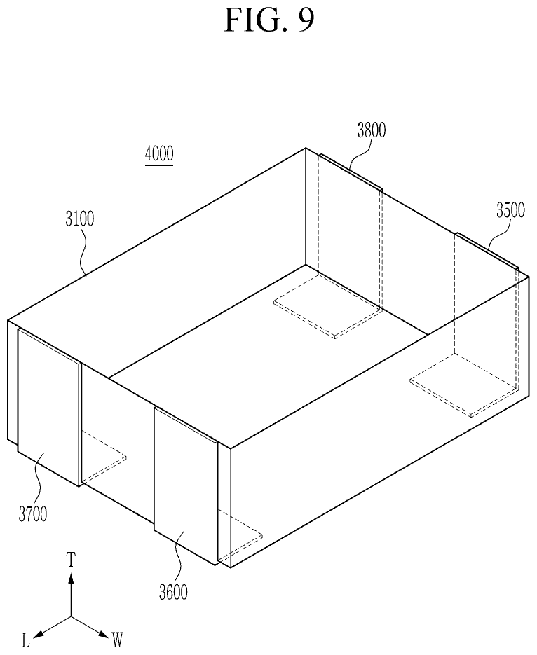

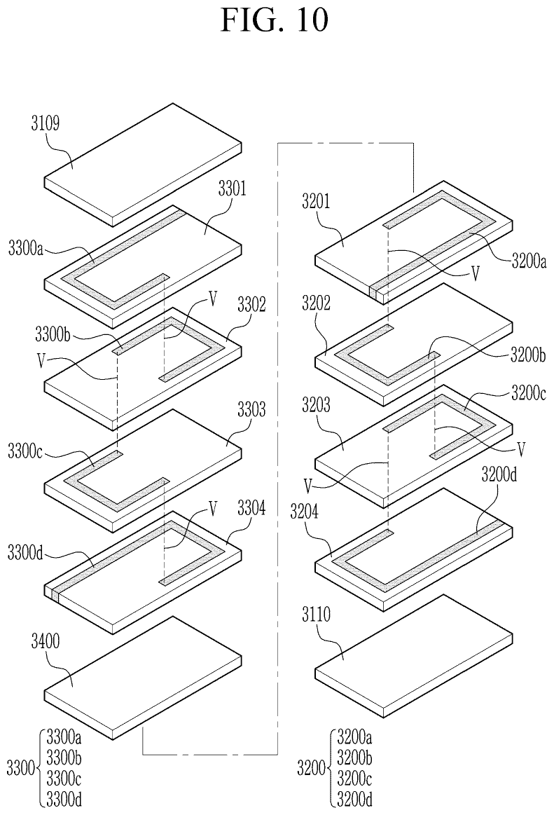

FIG. 9 illustrates a schematic perspective view showing a coil electronic component according to another embodiment, and FIG. 10 illustrates an exploded perspective view showing a body of the coil electronic component of FIG. 9.

Referring to FIG. 9 and FIG. 10, the coil electronic component 4000 may include a body 3100, a first coil 3200, a second coil 3300, an anisotropic magnetic layer 3400, a first external electrode 3500, a second external electrode 3600, a third external electrode 3700, and a fourth external electrode 3800.

The first coil 3200 and the second coil 3300 may be embedded in the body 3100, and the anisotropic magnetic layer 3400 may be disposed between the first coil 3200 and the second coil 3300.

The body 3100 may be a laminate made by stacking in the thickness direction T a plurality of magnetic sheets 3101, 3102, 3103, and 3104 on which conductive patterns 3200a, 3200b, 3200c, and 3200d comprising a portion of the first coil 3200 are disposed, a plurality of magnetic sheets 3105, 3106, 3107, and 3108 on which conductive patterns 3300a, 3300b, 3300c, and 3300d comprising a portion of the second coil 3300 are disposed, the anisotropic magnetic layer 3400, and a plurality of magnetic sheets 3109 and 3110 on which no conductive patterns are disposed.

The conductive patterns 3200a, 3200b, 3200c, and 3200d comprising a portion of the first coil 3200 may be electrically connected to each other through vias V.

The conductive patterns 3300a, 3300b, 3300c, and 3300d comprising a portion of the second coil 3300 may be electrically connected to each other through the vias V.

The remaining components are identical to the components of the coil electronic component shown in FIG. 1, so a repeated description thereof will be omitted.

### Preparation Example: Manufacture of Coil Electronic Components

### Comparative Example 1

A coil electronic component was manufactured in which two coils were embedded in the body and spaced apart from each other. A relative magnetic permeability of the body was 12.

### Example 1

It was the same as Comparative Example 1, except that an anisotropic magnetic layer with a relative magnetic permeability of 40 was disposed between the coils.

### Example 2

It was the same as Example 1, except that the relative magnetic permeability of the anisotropic magnetic layer was 50.

### Comparative Example 2

It was the same as Example 1, except that an isotropic magnetic layer with a relative magnetic permeability of 50 was disposed between the coils.

### Experimental Example: Coupling Coefficient

After manufacturing fifty (50) pieces of coil electronic components according to Examples 1 and 2 and Comparative Examples 1 and 2, inductances of the first and second coils were measured and the coupling coefficients were derived. Results thereof are summarized in Table 1.

TABLE 1

| | Inductance (nH) | | |
|---|---|---|---|
| | First coil | Second coil | Coupling coefficient |
| Comparative | 10.951 | 10.235 | −0.3462 |
| Example 1 | | | |
| Example 1 | 10.676 | 9.756 | −0.15824 |
| Example 2 | 11.035 | 10.041 | −0.13622 |
| Comparative | 13.015 | 11.865 | −0.21009 |
| Example 2 | | | |

Referring to Table 1, the coupling coefficient of the coil electronic components according to Examples 1 and 2 decreased compared to the coupling coefficient of the coil electronic components according to Comparative Examples 1 and 2. In particular, comparing the change in the coupling coefficient of Examples 1 and 2 and Comparative Example 2 with respect to Comparative Example 1, the coupling coefficient decreased more significantly in Examples 1 and 2 including the anisotropic magnetic layer.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A coil electronic component comprising:
a first coil;
a second coil spaced apart from the first coil;
an anisotropic magnetic layer disposed between the first coil and the second coil; and
a body surrounding the first coil, the second coil, and the anisotropic magnetic layer, the body comprising a magnetic material.

2. The coil electronic component of claim 1, wherein
the anisotropic magnetic layer is in contact with the first coil and the second coil.

3. The coil electronic component of claim 1, wherein
the anisotropic magnetic layer comprises plate-shaped or flake-shaped particles.

4. The coil electronic component of claim 3, wherein
the plate-shaped or flake-shaped particles include at least one selected from a group consisting of iron (Fe), a nickel-iron alloy (NiFe), an iron-silicon-aluminum alloy (FeSiAl), and an iron-silicon-chromium alloy (FeSiCr).

5. The coil electronic component of claim 1, wherein
the anisotropic magnetic layer includes a portion flush with an outer surface of the body.

6. The coil electronic component of claim 1, further comprising:
a first support member and a second support member embedded in the body and spaced apart from each other,
wherein the first coil is disposed on the first support member, and
the second coil is disposed on the second support member.

7. The coil electronic component of claim 6, wherein
the first coil comprises two coil patterns each of which is disposed on opposite surfaces of the first support member and that are connected to each other through a via penetrating the first support member, and
the second coil comprises two coil patterns each of which is disposed on opposite surfaces of the second support member and that are connected to each other through a via penetrating the second support member.

8. The coil electronic component of claim 1, wherein
the body comprises a laminate having a plurality of magnetic sheets stacked, and
each of the first coil and the second coil includes a plurality of conductive patterns disposed on each of the magnetic sheets and connected to each other.

9. The coil electronic component of claim 1, wherein
each of the first coil and the second coil includes at least one turn of a conductive wire.

10. The coil electronic component of claim 9, further comprising:
an insulating layer disposed on a surface of the conductive wire.

11. The coil electronic component of claim 1, further comprising:
a plurality of external electrodes disposed outside the body and connected to the first coil and the second coil.

12. The coil electronic component of claim 11, wherein
the plurality of external electrodes comprises a metal.

13. The coil electronic component of claim 12, wherein
the plurality of external electrodes comprises a metal and glass.

14. The coil electronic component of claim 1, further comprising:
a surface insulating layer covering at least a portion of a surface of the body.

15. The coil electronic component of claim 3, wherein the first coil and the second coil include winding axes extending in a first direction, and
wherein the anisotropic magnetic layer is oriented such that an angle between a direction perpendicular to a plane of the plate-shaped or flake-shaped magnetic particles and the first direction is less than an angle between the direction perpendicular to the plane of the plate-shaped or flake-shaped magnetic particles and a second direction that intersects the first direction.
